(19) United States
(12) Patent Application Publication
(10) Pub. No.: US 2003/0212797 A1
(43) Pub. Date: Nov. 13, 2003

(54) Setting management system for network connection

(75) Inventor: Naoto Kuroda, Nagano-ken (JP)

Correspondence Address: SUGHRUE MION, PLLC, 2100 Pennsylvania Avenue, NW, Washington, DC, 20037-3213, US

(73) Assignee: SEIKO EPSON CORPORATION

(21) Appl. No.: 10/400,058

(22) Filed: Mar. 27, 2003

(30) Foreign Application Priority Data
Mar. 28, 2002 (JP) 2002-93138(P)
Mar. 28, 2002 (JP) 2002-93140(P)
Feb. 17, 2003 (JP) 2003-37971(P)

(51) Int. Cl. G06F 15/16

(52) U.S. Cl. 709/227; 709/203

(57) ABSTRACT

In a setting management system for network connection of the present invention, a server 10 manages various sites and a network 30. The server 10 fetches current setting values with regard to network connection from a client 20, which is newly connected to the network 30. The server 10 refers to a client datable 11, a site database 12, and a sub-components memory module 13, specifies one or multiple sub-components and one or multiple indicated setting values for optimization, and sends the sub-components and the indicated setting values to the client 20. The client 20 optimizes the settings for network connection by means of the sub-components, based on the indicated setting values. This arrangement enables the settings for network connection to be automatically optimized in the client that is newly connected to the network.

### BACKGROUND OF THE INVENTION

1. Field of the Invention

The present invention relates to a technique that causes a client, which is newly connected to a network, to implement automatic setting for connection with the network.

2. Description of the Related Art

Diverse setting values including an address, a domain, a DNS server address, and a default gateway are required for connection of a computer to a network. In the case of connection to an intranet of an enterprise, installation of a specified virus eradication and protection program may be required as regulation for connection. The administrator of the network provides information required for such setting, and the user of the computer manually carries out setting based on the information.

The operations to implement such setting undesirably consume much time and labor of the user. In a large-scale enterprise having multiple offices, different settings may be required for the respective offices. The user is accordingly forced to carry out the troublesome operations every time the place of connection of the computer is varied. In the case of inadequate or insufficient settings, the computer may not receive a permission of connecting with the network or may be connected to a distant server taking long time for communication.

### SUMMARY OF THE INVENTION

The object of the present invention is thus to readily implement favorable setting for connection with a network in a client, which is newly connected to the network.

In order to attain at least part of the above and the other related objects, the present invention is directed to a setting management system that causes a client connected to a network to implement setting for connection with the network. The setting management system of the present invention has a site setting storage module and a program storage module. The site setting storage module stores a connection setting value intrinsic to a site, to which the client is connected. The site here represents a range of the network that is the object of management by the setting management system. The program storage module stores in advance a setting program, which runs on the client and is used for the setting. The setting management system transmits the connection setting value and the setting program to a client newly connected to the network. Namely the setting management system provides the client with the settings suitable for the site.

The setting management system of the present invention provides one or multiple connection setting values suitable for each site, together with one or multiple setting programs required for setting these values in the client. This arrangement desirably ensures favorable setting in the client without requiring the user of the client to have sufficient knowledge and detailed information with regard to the setting. The connection setting values may include setting values directly relating to connection, such as an address of a main server for managing sites, a DNS server address, and a default gateway. The connection setting values may also include setting values relating to rules for connection, such as the type of a virus eradication and protection program required for each site and authentication information, as well as time information for synchronization of the operations of the setting management system and the client.

In the setting management system of the present invention, the client may be any of diverse devices having the function of connecting with the network, for example, a general-purpose computer, a personal digital assistance or another portable terminal, a printer, a projector, or a scanner. The setting program may be created in any of various formats. For example, the setting program is described in the form of a script. In the case where wide-ranging functions are required for setting the client, it is preferable that the setting program consists of multiple single functional programs. This arrangement desirably provides the diverse functions required for setting the client, while reducing the communication traffic.

In one preferable application of the present invention, the setting management system may further include a client setting storage module, which stores a mapping of a connection setting value, which is intrinsic to a predetermined management unit in each client, to management code intrinsic to the predetermined management unit (hereinafter referred to as “management code”). The predetermined management unit may be a hardware unit of the client, an operating system activated on the client, or a user account. The setting management system obtains the management code from the client newly connected to the network, and transmits the connection setting value, which is intrinsic to the predetermined management unit and is mapped to the acquired management code. This arrangement ensures the favorable setting with reflection of the circumstances intrinsic to the predetermined management unit, for example, the operating system, the hardware structure, and the software configuration. The setting management system may be designed to urge the client to improve the capacity of the hardware or upgrade the version of the software.

In another preferable application of the present invention, the setting management system obtains current setting values with regard to connection with the network from the client, and specifies a connection setting value and a setting program, which are to be transmitted to the client, based on the current setting values. This arrangement desirably reduces transmission of non-required data and shortens the time required for the setting. One applicable procedure may exclude at least part of the connection setting value and the setting program, which are identical with the current setting values, from the transmitting contents. Another applicable procedure may select a connection setting value closer to a corresponding current setting value, among a plurality of available connection setting values.

The principle of the present invention is applicable to a system where an individual network is established for each site or to a system where multiple sites are mutually connected via a network. In the latter case, one preferable procedure stores multiple connection setting values corresponding to multiple sites, specifies a site, to which the client is connected, and transmits a connection setting value according to the result of specification. A diversity of methods may be applied for specification of the site. One applicable method defines an available address range for each site and specifies the site based on the address of the client. Another applicable method specifies the site, based on the report from the client or based on routing from the client to the setting management system.

The connection setting value may be transmitted in the form of a separate file from the setting program or in the form of an integrated file. In the latter case, in order to attain the selective use of multiple connection setting values corresponding to multiple sites, one preferable procedure transmits information for specifying a site, to which the client is connected, separately from a setting program including the multiple connection setting values corresponding to the multiple sites. Another preferable procedure creates a setting program including a connection setting value corresponding to a site, to which the client is connected, and transmits the setting program thus created.

The present invention is also directed to a client that implements setting for connection with a network, based on information received from the setting management system discussed above. The client is required to have a function of activating a received setting program.

The client may store intrinsic management code, which is to be transmitted to the setting management system. The client transmits the management code to the setting management system on connection with the network, and thereby receives a connection setting value and a setting program corresponding to the management code from the setting management system. The setting program is activated to carry out setting based on the connection setting value and thereby implement the setting with reflection of the inherent circumstances of the client.

In one preferable embodiment, the client stores multiple current setting values with regard to connection with the network, in addition to the management code, and transmits at least part of the current setting values, in addition to the management code. This arrangement enables setting in the client to be carried out by taking into account the current setting values.

The current setting values may include at least information for specifying a setting program stored in the client. This arrangement enables the setting management system to exclude the setting program stored in the client from the object of transmission, thereby effectively reducing the traffic. Such information may include the name and the version of the setting program.

The client may have a function of keeping information transmitted to the setting management system at a time of previous connection, as a log. This arrangement enables at least part of overlap of the log with the current setting values to be omitted from the information transmitted to the setting management system.

The present invention is not restricted to the setting management system and the client discussed above, but may be actualized in a diversity of other applications. Possible applications include a setting management method that causes a client to carry out setting for network connection, an automatic setting method that causes a client to implement automatic setting for network connection, as well as computer programs that cause the computer to execute the setting management method and the automatic setting method, and computer readable recording media in which such computer programs are recorded. Typical examples of the storage medium include flexible disks, CD-ROMs, magneto-optic discs, IC cards, ROM cartridges, punched cards, prints with barcodes or other codes printed thereon, internal storage devices (memories like a RAM and a ROM) and external storage devices of the computer, and a variety of other computer readable media.

The above and other objects, features, aspects, and advantages of the present invention will become more apparent from the following detailed description of the preferred embodiment with the accompanying drawings.

### BRIEF DESCRIPTION OF THE DRAWINGS

FIG. 1 schematically illustrates a network connection management system in one embodiment of the present invention;

FIG. 2 shows transmission of information between a server and a client in the network connection management system of FIG. 1;

FIG. 3 is a flowchart showing a client setting routine executed in the network connection management system of FIG. 1;

FIG. 4 is a flowchart showing another setting routine in a first modified example;

FIG. 5 is a flowchart showing still another setting routine in a second modified example; and

FIG. 6 is a flowchart showing another setting routine in a third modified example.

### DESCRIPTION OF THE PREFERRED EMBODIMENTS

One mode of carrying out the invention is discussed below as a preferred embodiment in the following sequence:

A. System Construction

B. Client Setting Process

C1. Modified Example (1)

C2. Modified Example (2)

C3. Modified Example (3)

A. System Construction

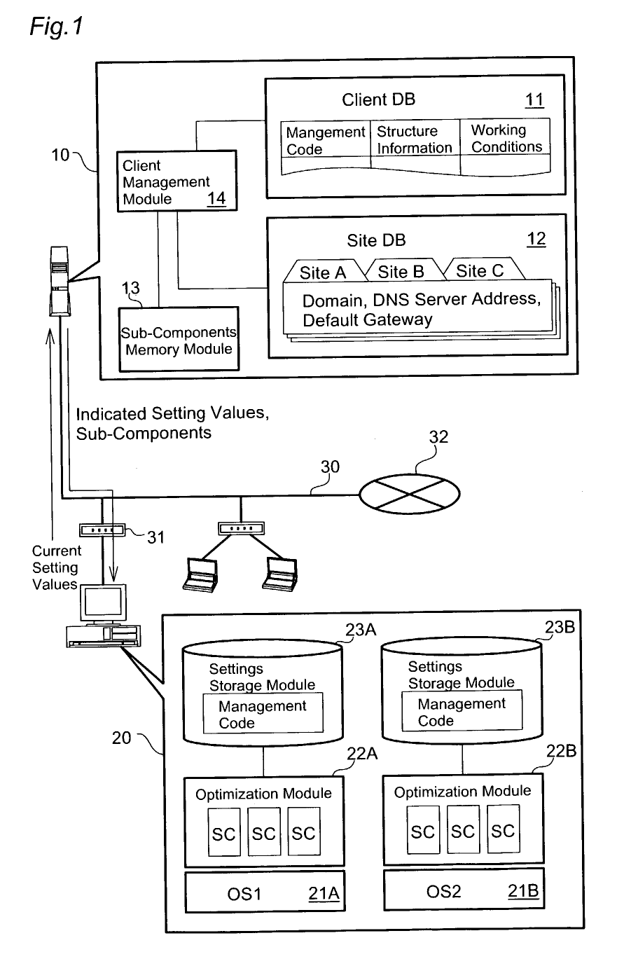

FIG. 1 schematically illustrates a network connection management system in one embodiment of the present invention. A network 30 is a LAN (local area network) established in an office of an enterprise. Systems similar to the illustrated system are constructed in other offices of the enterprise, and the systems in the respective offices are mutually communicable via a wide area communication network 32. Multiple clients 20 at a diversity of places are connectable to the network 30 via routers 31. The router 31 has DHCP functions and dynamically allocates an IP address to each client 20 in a preset address range according to the installation location of the router 31. The IP address may otherwise be allocated in advance by an administrator of the network 30 according to the place of connection of the client 20. A server 10 used for the management purpose is also connected to the network 30. The server 10 functions to implement setting in the client 20, so as to attain the optimum connection environment. The setting is carried out, for example, when the connection of the client 20 is changed between different offices of the enterprise. Hereafter the management range of the server 10 is referred to as a site.

FIG. 1 also shows the functional blocks of the server 10 and the client 20. In this embodiment, these functional blocks are actualized as the software configuration by installing computer programs for management of network connection. The functional blocks may alternatively be actualized as the hardware structure. It is not necessary that all the functional blocks are included in the server 10 and the client 20. Part of the functional blocks may be provided in the form of a recording medium like a CD-ROM or by another server.

The server 10 includes a client management module 14, a client database 11, a site database 12, and a sub-components memory module 13. The client database 11 stores therein information intrinsic to each client 20. In this embodiment, an intrinsic management code is allocated to each logical management unit of the client 20, as discussed later. The client 20 stores its structure information and working conditions mapped to the management code. The structure information includes, for example, the hardware structure including a CPU and a RAM, the type of an operating system used by the client 20, settings for network connection, such as a domain, and a virus eradication and protection program and other application programs installed in the client 20. The working conditions include, for example, a recommended hardware structure and information used for managing the license of the software programs. The servers 10 in the respective offices may have the client data base 11 of identical contents or may alternatively share the storage of different data with regard to different clients 20.

The site database 12 stores therein information intrinsic to each site, more specifically recommended setting values required for connection with the network 30. The information includes, for example, a domain, a DNS server address, a default gateway, and an IP address. Even when the connection of the client 20 is changed between different sites, reference to the information stored in the site database 12 desirably provides the client 20 with the favorable connection environment. The site database 12 may store information relating to other sites, in addition to the information relating to the sites under management of the server 10.

The sub-components memory module 13 stores sub-modules given to the client 20 to carry out setting for network connection (hereafter referred to as ‘sub-components’). In this embodiment, the sub-components are constructed in the form of XML files, in which scripts for attaining the respective functions are recorded. The sub-components are formed as individual files corresponding to the respective functions, in the structure of this embodiment. The sub-components may, however, be formed as one integrated file corresponding to all the functions.

The client management module 14 of the server 10 refers to the client database 11, the site database 12, and the sub-components memory module 13 and provides the client 20 with the favorable connection environment. On establishment of connection of the client 20 with the network 30, the client management module 14 fetches the current setting values including the management code and the IP address, refers to the respective databases 11 and 12, and sends one or multiple sub-components and one or multiple indicated setting values, which are required to carry out setting in the client 20, to the client 20. When the client 20 does not have any management code, the client management module 14 newly issues an inherent management code, which is not present in the client database 11, and gives the client 20 this newly issued management code.

In the client 20, a variety of application programs run on one or multiple preset operating systems (OS). The client 20 of this embodiment has the dual-boot structure; that is, two operating systems 21A and 21B are installed in the client 20. The client 20 has optimization modules 22A and 22B, which are actualized by software programs installed corresponding to the respective operating systems 21A and 21B. Each of the optimization modules 22A and 22B functions to activate a sub-component (shown by SC in FIG. 1) received from the server 10 and carry out setting in the client 20. Since the sub-components are constructed in the form of the XML files, the optimization modules 22A and 22B utilize a browser for interpretation and execution of the scripts recorded in the XML files.

The settings for network connection with regard to the operating systems 21A and 21B are respectively stored in settings storage modules 23A and 23B. More specifically, the settings used on the occasions of connection of the client 20 with any connection point are registered in the settings storage modules 23A and 23B. An intrinsic management code is allocated to each management unit of the settings in the client 20. The management code is not allocated to the hardware unit of the client 20 but is allocated to each of the multiple operating systems. When multiple users use the same client 20, the management code may be allocated to each user account. The unit for allocation of the management code may arbitrarily be specified, according to the requirements of divisional management of the settings for network connection.

In the structure of this embodiment, the settings storage modules 23A and 23B are files, in which the settings for network connection are stored for the management purpose. These files are different from reference files referred to by the operating system at the time of network connection, like a Hosts file and an LMHOSTS file, and are used for consolidated management of the contents set in the reference files. This arrangement advantageously facilitates acquisition of the current setting values.

In the description hereafter, it is assumed that a single management code is allocated to the client 20, that is, a single user uses only one OS on the client 20.

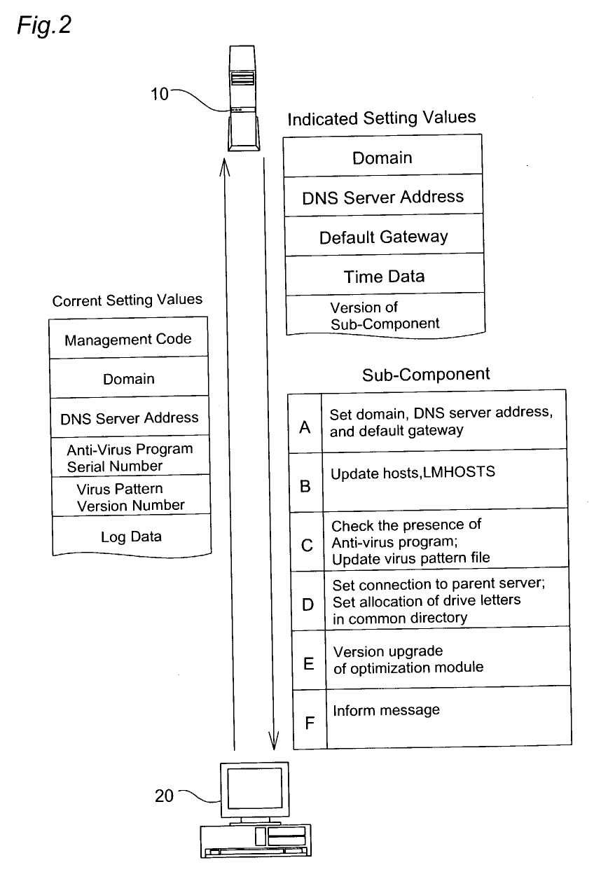

FIG. 2 shows transmission of information between the server 10 and the client 20. Current setting values are sent from the client 20 to the server 10. The current setting values represent the information stored in the settings storage modules 23A and 23B. Part or all of the information may be transmitted to the server 10. The current setting values include a management code, a domain, a DNS server address, a serial number of a virus eradication and protection program, a version number of a virus pattern file, and log data at the time of previous processing. The current setting values may also include an IP address allocated by the DHCP function.

The information transmitted from the server 10 to the client 20 includes indicated setting values and sub-components. The indicated setting values include a domain, a DNS server address, time data, and the version of each sub-component. In the structure of this embodiment, the server 10 specifies the site, to which the client 20 is connected, based on the IP address allocated to the client 20 and transmits the indicated setting values corresponding to the specified site. The site may otherwise be specified, based on the report from the client 20 or based on routing from the client 20 to the server 10. The indicated setting values may also include the specified IP address of a main server (the server 10 in this embodiment), to which the client 20 gains access. This arrangement ensures the smooth communication between the main server 10 and the client 20, even when the connection of the client 20 is changed between different sites. The time data is used to synchronize the time referred to for management of the versions of programs and data in the server 10 with the time in the client 20. The version of each sub-component is used to determine requirement or non-requirement of the sub-component from the server 10 to the client 20. Transmission of the sub-component is omitted, when the sub-component of the latest version has already been installed in the client 20.

Concrete examples of the sub-component are also shown in FIG. 2. In this embodiment, six sub-components are provided as individual files. A sub-component A functions to carry out automatic setting of a domain, a DNS server address, a default gateway, and the like. A sub-component B functions to automatically update Hosts files and LMHOSTS files in the computer. A sub-component C functions to check the presence or the absence of a virus eradication and protection program, download the virus eradication and protection program according to the requirements, and update a virus pattern file. A sub-component D functions to set connection with a parent server and allocation of drive data in a common directory. A sub-component E functions to upgrade the versions of the optimization modules 22A and 22B installed in the client 20. A sub-component F has functions of a messenger to transfer a message with high urgency to the client 20 for pop-up display. Any of these sub-components is appropriately selected according to the current setting values of the client 20 and is sent to the client 20.

In the structure of this embodiment, the indicated setting values may be included in the sub-component A. In this case, all the indicated setting values for multiple sites may be included in advance in the sub-component A. When the information for specifying a site, to which the client is connected, is transmitted as part of the indicated setting values, the sub-component A selects the indicated setting values corresponding to the specified site to carry out automatic setting.

B. Client Setting Process

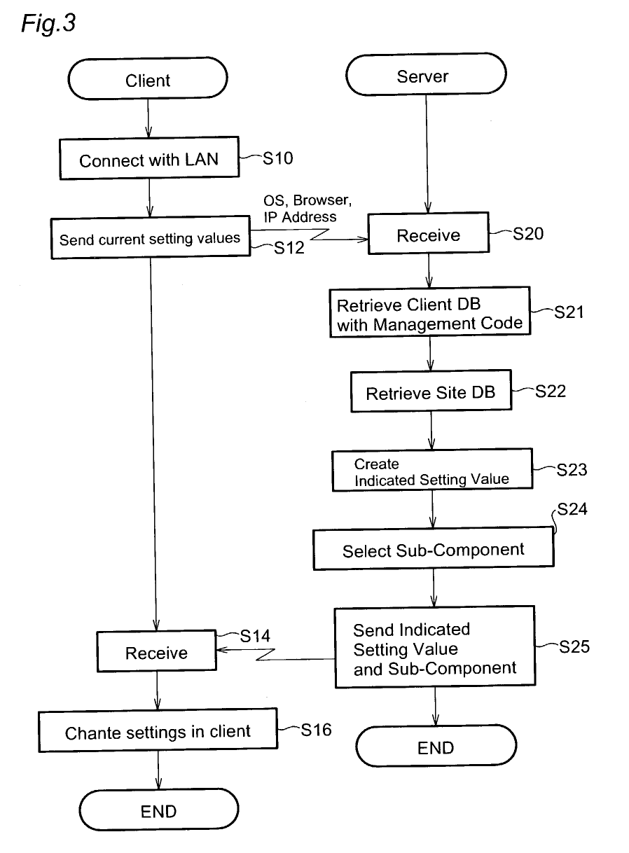

FIG. 3 is a flowchart showing a client setting routine. The left side shows a series of processing executed by the client 20, and the right side shows a series of processing executed by the server 10. After connection with the network 30 to log on (step S11), the client 20 first sends the current setting values to the server 10 (step S12). The current setting values include the type of the operating system, the type of the browser, and the IP address. The current setting values may be included in the data that are transmitted to the server 10 in the authentication process at the time of log-on. The server 10 may fetch the current setting values from the client 20, instead of the active transmission from the client 20.

The server 10 receives the current setting values (step S20) and activates the client management module 14 to carry out a series of setting process discussed below. The server 10 first retrieves the client database 11 with the management code included in the current setting values (step S21). The server 10 then specifies the site, to which the client 20 is connected, with the IP address and retrieves the site database 12 according to the result of the specification (step S22). The server 10 creates the indicated setting value, which is to be transmitted to the client 20, based on the results of the retrieval of these databases 11 and 12 (step S23), and selects the sub-component (step S24).

For example, when it is determined that the domain and the DNS server address set in the client 20 are inappropriate by referring to the current settings and the contents of the client database 11, the server 10 specifies the domain and the DNS server address recorded in the site database 12 as the indicated setting values. In the case where the sub-component A (see FIG. 2) has not yet been installed in the client 20, the server 10 selects the sub-component A as the object of transmission. In the case where the virus eradication and protection program essential for connection with the network 30 has not yet been installed in the client 20, the server 10 selects the sub-component C (see FIG. 2) as the object of transmission and urges the client 20 to install the virus eradication and protection program. In another preferable application, the server 10 may refer to the working conditions of the client 20 and, in the case of an insufficient capacity of its hardware structure, recommend the client 20 to enhance the capacity.

The server 10 sends the selected sub-component and the indicted setting value to the client 20 by utilizing an HTTP protocol (step S25). The client 20 receives the transmitted information (step S14), and changes the settings in the client 20 by means of the sub-component, based on the indicated setting value (step S16).

As discussed above, in the system of this embodiment, suitable setting values are transmitted as indicated setting values from the server 10 to the client 20, when the client 20 is connected to the network 30. The user of the client 20 can thus gain the favorable connection environment, without examining the detailed settings for the network 30.

The sub-component required for the setting is transmitted from the server 10 to the client 20 when the occasion demands. It is accordingly not necessary to provide an optimization module applicable for any connecting statuses. This advantageously facilitates the maintenance and management of the optimization modules 22A and 22B.

The network connection management system of this embodiment uses the management code for management of information regarding the client. This arrangement thus enables the inherent circumstances of the client, such as the right of access, to be reflected on the settings. The information required for the setting is divided into two groups for the management, that is, the information relating to the client and the information relating to the sites. This advantageously facilitates the management and the maintenance.

C1. Modified Example (1)

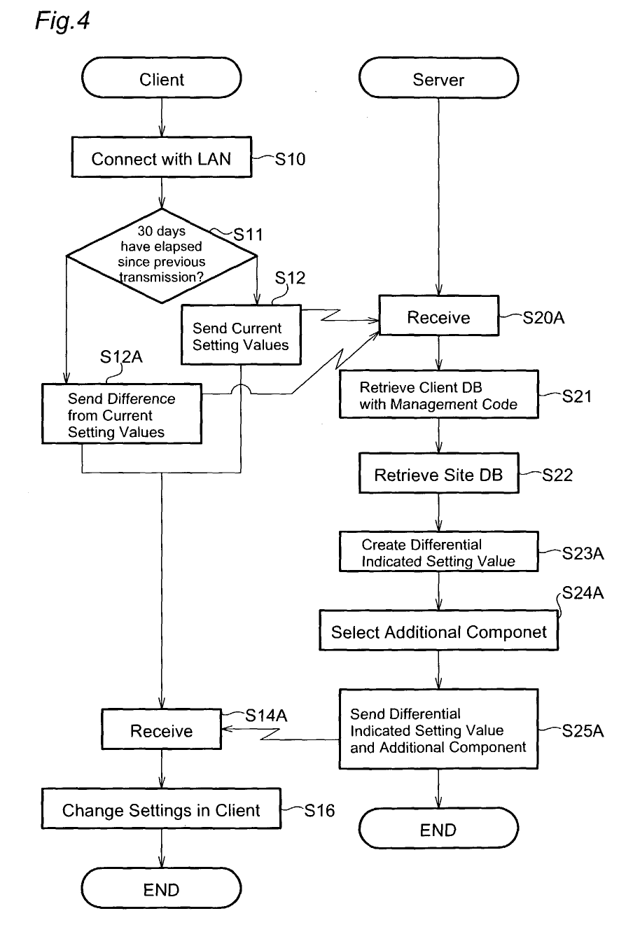

FIG. 4 is a flowchart showing another setting routine in a first modified example. After establishment of connection with the network 30 (step S10), the client 20 checks the log of the information sent to the server 10 last time and determines whether or not 30 days have elapsed since the previous transmission (step S11). When 30 days have not yet elapsed, the client 20 determines a difference between the current setting values and the contents of the log and transmits the difference to the server 10 (step S12A). When 30 days have already elapsed, on the other hand, the client 20 sends the current setting values to the server 10, in order to update the whole data under management of the server 10 for the purpose of confirmation (step S12). Here 30 days is only an example and is set as a reference date used for changing over the contents of transmission. Any suitable value may be set to this reference date. One possible modification may omit the decision step S11 and always send only the difference.

The server 10 receives the transmitted difference (step S20A), so as to update the client database 11. The server 10 also retrieves the client database 11 and the site database based on the received difference (steps S21 and 22), creates a differential indicated setting value (step S23A), selects an additional component (step S24A), and sends the differential indicated setting value and the additional component to the client 20 (step S25A). The differential indicated setting value represents the indicated setting value with regard to a specific item, which requires change of the setting in the client 20. The additional component represents a sub-component that is to be newly transmitted to the client 20. The differential indicated setting value and the additional component may not correspond to the difference received from the client 20. One applicable procedure may specify the differential indicated setting value and the additional component with regard to an item other than that corresponding to the difference received from the client 20, according to the requirements. The client 20 receives the differential indicated setting value and the additional component (step S14A), and changes the settings in the client 20, based on the received information (step S16).

The arrangement of the first modified example desirably reduces the quantity of data transmission between the client 20 and the sever 10. This arrangement is especially effective on the occasion of concentration of connection with the network, for example, at the start time of business day.

C2. Modified Example (2)

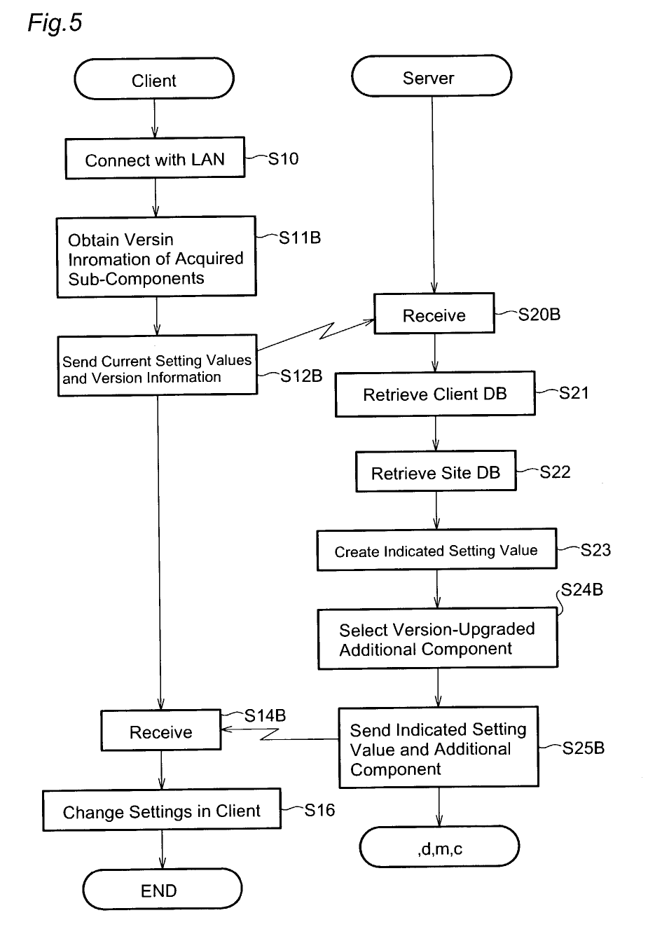

FIG. 5 is a flowchart showing still another setting routine in a second modified example. After establishment of connection with the network 30 (step S10), the client 20 first checks the version of each acquired sub-component (step S11B). The version is managed by the settings storage modules 23A and 23B included in the client 20. The client 20 then transmits information regarding the current setting values and the IDs and the versions of the stored sub-components to the server 10 (step S12B).

The server 10 receives the transmitted information (step S20B), retrieves the client database 11 and the site database 12 (steps S21 and S22), and creates an indicated setting value (step S23) in the same manner as that of the embodiment discussed above. The server 10 then selects an additional component (step S24B). In the second modified example, a version-upgraded sub-component, that is, a sub-component of the later version than the version of the corresponding sub-component stored in the client 20 is selected as the additional component. The additional component may otherwise be a sub-component that is not stored in the client 20. The server 10 sends the indicated setting value and the additional component to the client 20 (step S25B). The client 20 receives the indicated setting value and the additional component (step S14B) and changes the settings in the client 20, based on the received information (step S16).

The arrangement of the second modified example ensures transmission of a selected sub-component of the latest version to the client 20, while desirably reducing the quantity of data transmission for this purpose.

C3. Modified Example (3)

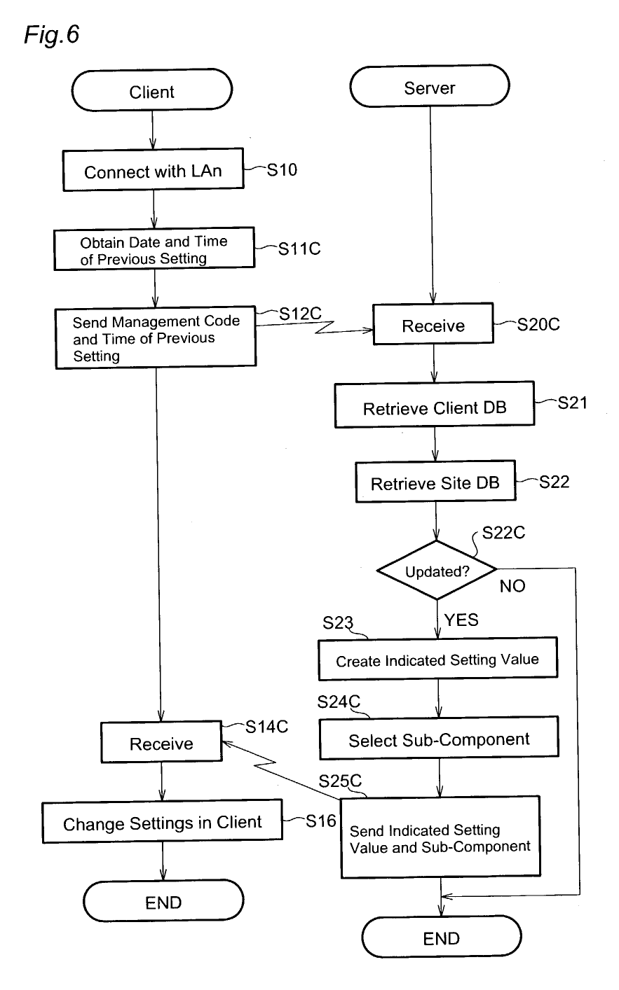

FIG. 6 is a flowchart showing another setting routine in a third modified example. In the arrangement of the third embodiment, every time the settings are changed, the client 20 stores the date and the time of the change in the settings storage modules 23A and 23B. After establishment of connection with the network 30 (step S10), the client 20 acquires the date and time of the previous setting (step S11C) and transmits the acquired date and time of the previous setting, together with the management code, to the server 10 (step S12C). The server 10 receives the transmitted information (step S20C), retrieves the client database 11 and the site database 12 (steps S21 and S22), and determines whether or not these databases 11 and 12 have been updated since the previous setting (step S22C). When the databases have not yet been updated since the previous setting, it is determined that no setting is required at this moment. The program accordingly exits from this setting routine. When the databases have been updated since the previous setting, on the other hand, the server 10 and the client 20 function to change the settings in the same manner as that of the embodiment discussed above (steps S23, S24C, S25C, S14C, and S16).

The arrangement of the third modified example determines the requirement for updating the settings in the client 20, based on the date and time of the previous setting. This desirably reduces non-required transmission of the indicated setting values and the sub-components, thus effectively preventing the high traffic.

The arrangements of the above embodiment and the first through the third modified examples may be combined according to the requirements.

The above embodiment and its modified examples are to be considered in all aspects as illustrative and not restrictive. There may be many modifications, changes, and alterations without departing from the scope or spirit of the main characteristics of the present invention. All changes within the meaning and range of equivalency of the claims are therefore intended to be embraced therein.

The scope and spirit of the present invention are indicated by the appended claims, rather than by the foregoing description.

What is claimed is:

1. A setting management system that causes a client connected to a network to implement setting for connection with the network, said setting management system comprising:
a site setting storage module that stores a connection setting value intrinsic to a site, to which the client is connected;
a program storage module that stores in advance a setting program, which runs on the client and is used for the setting; and
a transmission module that transmits the connection setting value and the setting program to a client newly connected to the network.

2. A setting management system in accordance with claim 1, said setting management system further comprising:
a client setting storage module that stores a mapping of a connection setting value, which is intrinsic to a predetermined management unit in each client, to identification information intrinsic to the predetermined management unit; and
an information acquisition module that obtains the identification information from the client newly connected to the network,
wherein said transmission module transmits the connection setting value, which is intrinsic to the predetermined management unit and is mapped to the acquired identification information.

3. A setting management system in accordance with claim 2, wherein the predetermined management unit is any one of a hardware unit of the client, an operating system activated on the client, and a user account.

4. A setting management system in accordance with claim 1, said setting management system further comprising:
a current status acquisition module that obtains current setting values with regard to connection with the network from the client; and
a transmitting contents specification module that specifies a connection setting value and a setting program, which are to be transmitted to the client, based on the current setting values.

5. A setting management system in accordance with claim 4, wherein said transmitting contents specification module excludes at least part of the connection setting value and the setting program, which are identical with the current setting values, from the transmitting contents.

6. A setting management system in accordance with claim 1, said setting management system further comprising:
a site specification module that specifies a site, to which the client is connected,
wherein said site setting storage module stores connection setting values mapped to multiple sites, and
said transmission module transmits a connection setting value corresponding to the specified site.

7. A client that carries out setting for connection with a network, based on information received from a server connecting with the network, said client comprising:
a setting memory module that stores intrinsic identification information allocated to each management unit on the network;
an information transmission module that transmits the identification information to said server when said client is connected to the network;
a reception module that receives a connection setting value and a setting program from said server, according to the identification information; and
a setting control module that activates the setting program to carry out setting, based on the connection setting value.

8. A client in accordance with claim 7, wherein said setting memory module stores current setting values with regard to connection with the network, in addition to the identification information, and
said information transmission module transmits at least part of the current setting values, in addition to the identification information.

9. A client in accordance with claim 8, wherein the current setting values include at least information for specifying a setting program stored in said client.

10. A client in accordance with claim 8, said client further comprising:
a log storage module that keeps information transmitted to said server at a time of previous connection, as a log,
wherein said information transmission module omits at least part of overlap of the log with the current setting values and transmits the information other than the omitted part.

11. A setting management method that causes a client connected to a network to implement setting for connection with the network, said setting management method comprising the steps, which are executed by a server connecting with the network:
referring to a database that stores in advance a connection setting value intrinsic to a site, to which said client is connected;
referring to a database that stores in advance a setting program, which runs on said client and is used for the setting; and
transmitting the connection setting value and the setting program to a client newly connected to the network.

12. An automatic setting method that causes a client to carry out automatic setting for connection with a network, based on information received from a server connecting with the network, said automatic setting method comprising the steps of:
storing in advance intrinsic identification information allocated to each management unit on the network;
transmitting the identification information to said server when said client is connected to the network;
receiving a connection setting value and a setting program from said server, according to the identification information; and
activating the setting program to carry out setting, based on the connection setting value.

13. A computer readable recording medium in which a computer program that causes a client connected to a network to implement setting for connection with the network is recorded, said computer program causing a server connecting with the network to attain the functions of:
referring to a database that stores in advance a connection setting value intrinsic to a site, to which said client is connected;
referring to a database that stores in advance a setting program, which runs on said client and is used for the setting; and
transmitting the connection setting value and the setting program to a client newly connected to the network.

14. A computer readable recording medium in which a computer program that causes a client to carry out automatic setting for connection with a network, based on information received from a server connecting with the network is recorded, said computer program causing said client to attain the functions of:
storing in advance intrinsic identification information allocated to each management unit on the network;
transmitting the identification information to said server when said client is connected to the network;
receiving a connection setting value and a setting program from said server, according to the identification information; and
activating the setting program to carry out setting, based on the connection setting value.
